(19) United States
(12) Patent Application Publication
(10) Pub. No.: US 2016/0218979 A1
(43) Pub. Date: Jul. 28, 2016

(54) APPARATUS AND METHOD FOR TRANSMITTING PACKETS THROUGH MULTI-HOMING BASED NETWORK

(71) Applicant: Electronics and Telecommunications Research Institute, Daejeon-si (KR)

(72) Inventor: Hyun Suk ROH, Daejeon-si (KR)

(73) Assignee: Electronics and Telecommunications Research Institute, Daejeon-si (KR)

(21) Appl. No.: 14/995,301

(22) Filed: Jan. 14, 2016

(30) Foreign Application Priority Data
Jan. 23, 2015 (KR) 10-2015-0011378

(51) Int. Cl. H04L 12/803; H04L 12/26; H04L 12/801

(52) U.S. Cl. CPC H04L 47/122; H04L 47/11; H04L 47/34; H04L 43/16

(57) ABSTRACT

The present disclosure relates to a communication path control technology, and more specifically, to technology for selecting a network and scheduling packets for multi-homing based transmission. The objective of the present disclosure is to reduce a packet loss by determining the number of packets to be transmitted based on the degree of congestion on each network path for a multi-homing based transmission technology. A packet transmission apparatus selects a network path to be used to transmit a packet based on congestion information, which is calculated based on state information of each network path, and then allocates the number of packets to be transmitted and sequence numbers of the packets to the selected network path.

### CROSS REFERENCE TO RELATED APPLICATION

This application claims the benefit under 35 U.S.C. §119(a) of Korean Patent Application No. 10-2015-0011378, filed on Jan. 23, 2015, the entire disclosure of which is incorporated herein by reference for all purposes.

### BACKGROUND

1. Field

The following description relates to a communication path control technology, more specifically, to a technology for selecting a network and scheduling packets for multi-homing based transmission.

2. Description of Related Art

Recently a technology for transmitting data using multiple network paths has been developed while its standardization is in progress, and the services through the multiple network paths have been widely provided. In Korea, as multi-homing based transmission services, a heterogeneous network integration solution service supported by SK Telecom and a multi-access packet data network (PDN) connectivity service supported by KT have been available. In other countries, NIC bonding of Iomega, bandwidth bonding of Xroads Networks, and the like have gained attention as the multi-homing based transmission technologies. Internet Engineering Task Force (IETF) has established multipath transmission control protocol (MPTCP) as a multi-homing based transmission technology standard.

In the existing multi-homing based transmission technologies, the amount of data to be transmitted is determined without taking into account a degree of congestion on each network path. Accordingly, a large amount of packets may happen to be transmitted through a congested network path, which causes a significant amount of packet loss. In addition, data is divided and transmitted through a plurality of network paths, and thus out-of-order arrival of packets at a destination occurs due to latency differences among network paths.

Therefore, a method for selecting a specific network path by taking into consideration the degree of congestion on each network path is required in order to increase the performance of multi-homing based transmission technology, and also a packet scheduling method that can prevents the out-of-order arrival of packets is needed.

### SUMMARY

One objective of the present disclosure is to reduce a packet loss by determining the number of packets to be transmitted based on the degree of congestion on each network path for a multi-homing based transmission technology.

Another objective of the present disclosure is to prevent the out-of-order arrival of packets at a client by determining sequence numbers of packets to be transmitted through each network path based on the degree of congestion on each network path.

In one general aspect, there is provided a packet transmission apparatus for transmitting a packet using multi-homing based network paths, the packet transmission apparatus including: a congestion information calculator configured to calculate congestion information of each of a plurality of network paths based on state information of each network path; a path selector configured to select a network path to be used for packet transmission based on the calculated congestion information; and a packet allocator configured to allocate, to the selected network path, the number of packets to be transmitted through the selected network path and sequence numbers of the packets.

The congestion information calculator may calculate the congestion information based on state information of each of the plurality of network path, and the state information contains at least one of the following: a packet latency, a throughput, and a packet loss probability.

The packet transmission apparatus may further include a state information updater configured to update state information that is included in feedback information sent from a client which received a packet through each network path.

The congestion information calculator may calculate the congestion information of each network path by comparing a maximum latency threshold, calculated based on state information, to a current latency of a packet that is transmitted via the network path.

The path selector may select a specific network path as the network path to be used for packet transmission when it is determined based on the calculated congestion information that a currently latency of a packet transmitted via the specific network path is smaller than the maximum latency threshold.

The packet transmission apparatus may further include a sorter configured to create data by arranging network paths which are selected, based on the maximum latency threshold of each network path, from among the network paths that the path selector determines to be used for packet transmission.

The packet allocator may allocate, to each network path, the number of packets to be transmitted through the network path and the sequence number based on a packet latency difference between the network paths and a packet reception interval of the network path.

The packet allocator may allocate the number of packets to be transmitted and sequence numbers of the packets to each of network paths which are connected to a plurality of interfaces included in the packet transmission apparatus.

The packet transmission apparatus may further include a packet transmitter configured to transmit packets through a network path to which the number of packets to be transmitted and the sequence numbers of the packets are completely allocated.

In yet another general aspect, there is provided a method for transmitting packets using multi-homing based network paths, the method including: calculating congestion information of each of a plurality of network paths based on state information of each network path; selecting a network path to be used for packet transmission based on the calculated congestion information; and allocating, to the selected network path, the number of packets to be transmitted through the selected network path and sequence numbers of the packets.

Other features and aspects will be apparent from the following detailed description, the drawings, and the claims.

### BRIEF DESCRIPTION OF THE DRAWINGS

FIG. 1 is a diagram illustrating a multi-homing based packet transmission apparatus, networks, and a client.

FIG. 2 is a diagram illustrating a plurality of clients located within areas of multiple networks.

FIG. 3 is a diagram illustrating a configuration of the packet transmission apparatus according to the exemplary embodiment.

FIG. 4 is a diagram for explaining a packet transmission latency and a packet reception interval of each network path.

FIG. 5 is a diagram illustrating a configuration of a client according to an exemplary embodiment.

FIG. 6 is a flowchart illustrating a method of packet transmission between a packet transmission apparatus and a client according to an exemplary embodiment.

FIG. 7 is a flowchart illustrating in detail the packet transmission method of claim 6.

FIG. 8 is a flowchart illustrating procedures of the client that receives a packet via multiple network paths and transmits feedback information.

Elements, features, and structures are denoted by the same reference numerals throughout the drawings and the detailed description, and the size and proportions of some elements may be exaggerated in the drawings for clarity and convenience.

### DETAILED DESCRIPTION

The following description is provided to assist the reader in gaining a comprehensive understanding of the methods, apparatuses, and/or systems described herein. However, various changes, modifications, and equivalents of the methods, apparatuses, and/or systems described herein will be apparent to those of ordinary skill in the art. The sequences of operations described herein are merely examples, and are not limited to those set forth herein, but may be changed as will be apparent to one of ordinary skill in the art, with the exception of operations necessarily occurring in a certain order. Also, descriptions of well-known functions and constructions that are well known to one of ordinary skill in the art may be omitted for increased clarity and conciseness.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

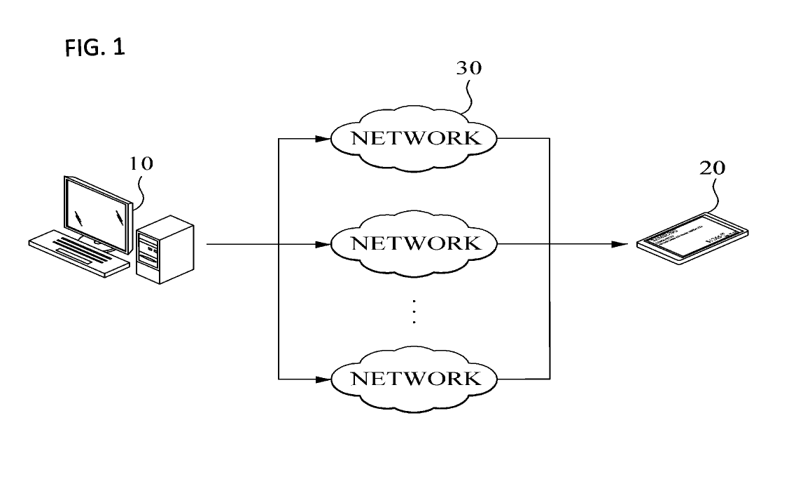

FIG. 1 is a diagram illustrating a multi-homing based packet transmission apparatus, networks, and a client. Multi-homing is a technology that enables Internet nodes, sites, and the networks 30 to remain connected to multiple homogeneous or heterogeneous links using multi-IP address. Among multi-homing based transmission technologies, heterogeneous network integration solution is a technology that integrates two different types of wireless networks that employ different wireless connection technologies and frequency bands and ensures faster data services, as compared to the case of using a single network. Multi-access packet data network (PDN) connectivity integrates an LTE network and a Wi-Fi network by combining Wi-Fi integrated Long Term Evolution (LTE) Femtocell with Always Best Connected (ABC) technology, which enables simultaneous data transmission between heterogeneous networks, and there provides a data transfer rate of up to 130 Mbps by simultaneously transmitting data over the integrated network. Network Interface Card (NIC) bonding increases a bandwidth by transmitting data to two or more network interface cards using one IP address. In addition, NIC bonding supports a network interface failover function, whereby a malfunctioning network interface is changed to another network interface in standby mode, thereby achieving reliability. Furthermore, NIC bonding efficiently distributes packets through adaptive load balancing. Bandwidth bonding combines a plurality of ISP connections with a cache engine to increase a download speed on the web, so that an available bandwidth can be increased by simultaneously using a number of connections in the same session. Consequently, bandwidth bonding can ensure an increase in download speed and reduce network congestion. According to multipath transmission control protocol (MPTCP), which is a standardized transmission protocol, data is transmitted simultaneously through multiple physical network paths using multiple TCP connections in order to increase transmission performance. MPTCP can increase a data throughput and the reliability in data transmission.

As shown in FIG. 1, the packet transmission apparatus 10 is interfaced to the client 20 and the multiple networks 30. By using a method which will be described below, the packet transmission apparatus 10 selects a network path along which to transmit packets and schedules packets in order to enable the client 20 to sequentially receive the packets. Although not explicitly illustrated, the packet transmission apparatus 10 may communicate with other servers via a backbone network 30.

In one example, the client 20 receives a packet from the packet transmission apparatus 10. A packet is a formatted block of data to be transmitted over a packet computer network 30. The packet consists of a header, the payload, and a trailer. The header contains an address of the packet, and the payload contains the actual information. The client 20 that has received the packet transmits feedback information for each network path to the packet transmission apparatus 10. The client 20 refers to a communication terminal which is capable of Internet protocol (IP)-based data communication. For example, the client 20 may be a mobile phone, a smartphone, a laptop computer, a desktop computer, an electronic book reader, and the like, but the client 20 is not limited thereto and may be any wireless communication device which is capable of receiving a data packet from the packet transmission apparatus 10.

In one example, the network 30 is a group of terminals, links, and nodes that are connected to each other in order to enable terminal users to communicate with each other. That is, the network 30 is a data communication system to support multiple independent devices to directly communicate with each other within an appropriate area through physical s communication channels at a moderately fast speed. The packet transmitted from the packet transmission apparatus 10 is delivered to the client 20 through the network 30.

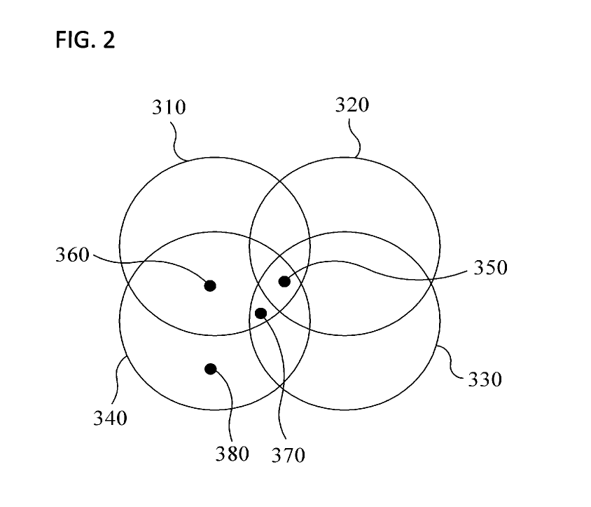

FIG. 2 is a diagram illustrating a plurality of clients located within areas of multiple networks. The multiple networks 30 of FIG. 1 which connect the client 20 and the packet transmission apparatus 10, as shown in FIG. 1, may be one of networks that support IP-based packet data services. The network may be, for example, wireless personal area network (WPAN), a wireless local area network (WLAN), a general packet radio service (GPRS) network, a global system for mobile network (GSM), a code division multiple access (CDMA) network, a wideband CDMA (WCDMA) network, and 3^{rd} generation (3G) evolution (3GE) network. As shown in FIG. 2, the clients 350, 360, and 370 that are located within the overlapping coverage areas of the heterogeneous networks are capable of using multiple networks, and the client 380 within the non-overlapping coverage area of the network is able to use only one network. The packet transmission apparatus 10 prevents any packet loss and throughput degradation during transmission of a packet, by using an algorithm that will be described below.

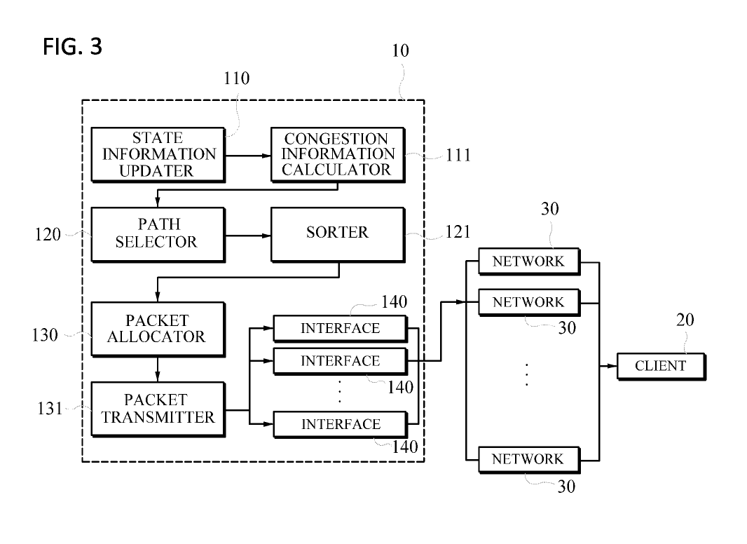

FIG. 3 is a diagram illustrating a configuration of the packet transmission apparatus according to the exemplary embodiment. The packet transmission apparatus 10 that transmits a packet by using the multi-homing based network paths includes a congestion information calculator 111, a path selector 120, and a packet allocator 130. In one example, the congestion information calculator 111, the path selector 120, and the packet allocator 130 may be implemented by program instruction sets that are executed on a microprocessor. The congestion information calculator 111 calculates congestion information for each network 30 based on state information of each network path. The congestion information calculator 111 calculates the congestion information by comparing the maximum latency threshold, which is calculated based on the state information, to a current latency of the packet transmitted via the network path. The congestion information contains data of comparison between the maximum latency threshold and the current latency. If the maximum latency threshold of an arbitrary network 30 is smaller than the current latency of the packet, the congestion information calculator 111 generates the congestion information to indicate that the maximum latency threshold is smaller than the current latency. In one exemplary embodiment, the maximum latency threshold is the maximum packet latency during which a packet loss does not occur, and after which a packet loss starts occurring. In another exemplary embodiment, the maximum latency threshold is the longest packet latency during which a packet loss does not occur. However, aspects of the present disclosure are not limited thereto, such that the maximum latency threshold can be set to a different value according to the type of client 20.

In one exemplary embodiment, the congestion information calculator 111 calculates congestion information of the current network path and checks whether congestion information has been completely calculated for all network paths connected to the client 20. If there are remaining network paths whose the congestion information has not been yet calculated, the congestion information calculator 111 selects one of the remaining network paths and then calculates congestion information of the selected network path until the congestion information is calculated for all network paths.

The path selector 120 selects a network path to be used for packet transmission based on the congestion information of each network path. The path selector 120 selects a network path that has smaller current packet latency than the maximum latency threshold, based on the calculated congestion information. The path selector 120 adds the selected network path to a list of network paths available for transmission of a packet. There may be one or more selected network paths or none at all.

The packet allocator 130 allocates the number of packets and sequence numbers of the packets to the selected network path. The packet allocator 130 will be described in detail below.

In one aspect, the packet transmission apparatus 10 further includes a state information updater 110. The state information updater 110 updates state information that is contained in the feedback information sent by the client 20 which has received the packets through the multiple network paths. The feedback information contains at least one of the following information: a packet latency, a packet reception interval, a throughput, and a packet loss probability of each network path. The state of the network path may change over time. The number of packets to be transmitted via each network path and the sequence numbers of the packets depend on the congestion information calculated based on the state information of the network path. Once the state information is updated, the number of packets and the sequence numbers of the packets that are suitable to the current state of each network path can be allocated to each network path. The client 20 transmits feedback information to the packet transmission apparatus 10, each time receiving the packet, and the packet transmission apparatus 10 calculates congestion information based on the state information, each time receiving the feedback information. When the congestion information that includes traffic status of each network path is altered, the number of packets and the sequence numbers of the packets for each network path may be modified in order to ensure the optimal quality of wireless communication. As the packet transmission apparatus 10 continuously receives feedback information from the client 20 and the state information updater 110 updates the state information of each network path, it is possible to immediately and flexibly response to changes in communication environment. The state information is not limited to the aforesaid information and may include any factors that allow the evaluation of the network performance. The factors may include the delay spread, an error rate, multicasting/broadcasting capabilities, document cache, and the like. The packet latency, the packet reception interval, the throughput, the packet loss probability, the delay spread, and the error rate will be described in detail below. In one exemplary embodiment, the state information updater 110 is implemented by program instruction sets to be executed on a microprocessor that is included in the packet transmission apparatus 10. However, aspects of the present disclosure are not limited thereto, such that the state information updater 110 may be implemented by dedicated hardware, for example, sequential and/or combinational logic circuit.

In one aspect, the packet transmission apparatus 10 may include a sorter 121. The sorter 121 creates data by arranging network paths which are selected, based on the maximum latency threshold of each network path, from among the network paths that the path selector 120 determines to be used for packet transmission. The sorter 121 will be described in detail below.

In one aspect, the packet transmission apparatus 10 may include a packet transmitter 131. The packet transmitter 131 transmits packets through the network path for which the number of packets and the sequence numbers of the packets have been allocated. Once the packet allocator 130 has completed the allocation of the number of packets and the packet sequence numbers for every network path connected to a plurality of interfaces, the packet transmitter 131 transmits packets according to the allocated number of packets and sequence numbers of the packets. In one exemplary embodiment, the packet transmitter 131 is implemented by program instruction sets to be executed on a microprocessor included in the packet transmission apparatus 10. However, aspects of the present disclosure are not limited thereto, such that the packet transmitter 131 may be implemented by dedicated hardware, for example, sequential and/or combinational logic circuit.

A server to transmit a packet from the packet transmission apparatus 10 to the client 20 may be a separate process that is executed on physically the same server. The nowadays computing technology enables a single physical server to be operated as multiple logical servers. Moreover, the multiple logical servers may not be implemented as separate logical servers, but as different processes that are executed on a single logical server. Furthermore, the entire multiple logical servers may be implemented as a single program.

In one example, an interface 140 refers to a physical network interface at the packet transmission apparatus side in a multi-homing environment. Each interface 140 is connected to the client 20 over the network 30.

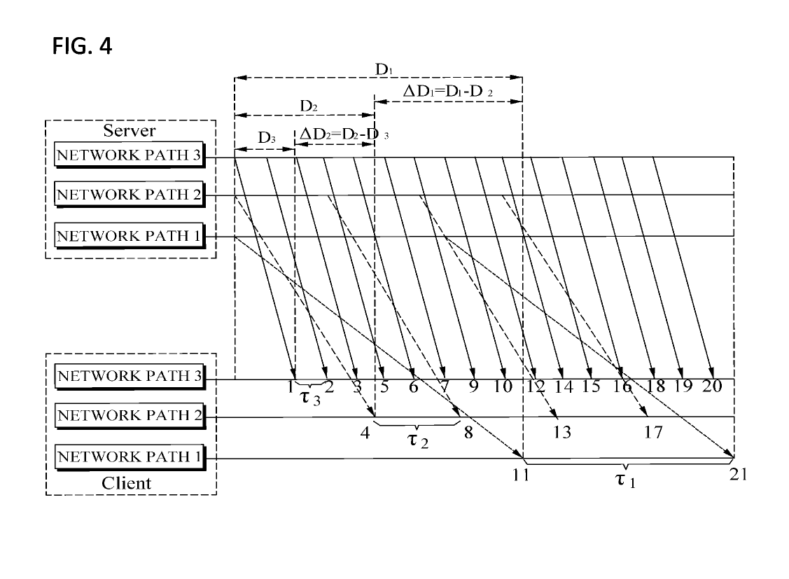

FIG. 4 is a diagram for explaining a packet transmission latency and a packet reception interval of each network path. In one exemplary embodiment, the state information contains at least one of the following: a packet latency, a packet reception interval, a throughput, and a packet loss probability. The state information will be described in detail later. Reference numerals D1, D2, and D3 shown in FIG. 4 each denote a packet latency. The packet latency is the time from the sending of a packet by the packet transmission apparatus 10 through one network path to the receiving of the packet by the client 20. That is, the packet latency is the time spent by a packet to travel from one point to another point at the speed of light.

Reference numerals τ₁, τ₂, and τ₃ each denote a packet reception interval. For example, the packet reception interval may be an interval at which the client 20 receives packets through one of the network paths. In another example, the packet reception interval may be an interval at which the packet transmission apparatus 10 transmits packets.

The packet throughput is also called a bit rate, which is the number of bits that pass a given point in the network 30 in a given amount of time when two terminal systems, i.e., the packet transmission apparatus 10 and the client 20 communicate with each other.

The packet loss probability refers to a probability that a packet traveling in the network will be lost due to interruption or the like.

The state information is not limited to the aforementioned information, and may include any factors that allow the evaluation of the network performance. The factors may include a delay spread, an error rate, multicasting/broadcasting capabilities, document cache, and the like. For example, the delay spread is a physical jitter that is distinguished from a jitter which is caused only by transmission equipment. All networks 30 have a physical jitter. This is because a repeater that reforms a signal may sometimes operate unpredictably or, in the case of a metal conductor, a propagation delay and the like is changed according to changes in temperature.

For example, the error rate depends on data changes, data loss, data duplication, out-of-order transmission of data. A network error is measured as a bit error rate, a packet/cell error rate, a packet/cell loss probability, and the like.

In one exemplary embodiment, the packet allocator 130 allocates the number of packets to be transmitted and the sequence numbers of the packets to each network path based on a packet latency difference between networks 30 and the packet reception intervals of the networks 30. In FIG. 4, ΔDᵢ denotes a difference between a latency Dᵢ of the i-th network path and a latency D₍ᵢ₊₁₎ of the (i+1)-th network path, where i starts with 1. The packet allocator 130 increases i by one after calculating ΔDᵢ, and checks whether the i-th network path is the last network path of the network path list. If the i-th network path is not the last one, the packet allocator 130 continuously calculates ΔDᵢ until the i-th network path becomes the last network path of the network path list. If the number i reaches the last number of the network path, the packet allocator 130 changes i to 1 and calculates the number nᵢ of packets to be transmitted via the (i+1)-th network path during ΔDᵢ by dividing ΔDᵢ by τ₍ᵢ₊₁₎.

In addition, the packet allocator 130 allocates the number of packets to be transmitted and the sequence numbers of the packets to each network path connected to multiple interfaces that are included in the packet transmission apparatus 10. As shown in FIG. 4, once the number of packets to be transmitted via the (i+1)-th network path is determined, the packet allocator 130 increases i by one and checks whether the i-th network path is the last network path of the network path list. If the i-th network path is the last network path, the packet allocator 130 determines the number of packets to be transmitted via the network path in question and does not increase i any longer. If the i-th network path is not the last one in the network path list, the packet allocator 130 continuously increase i by one until the number i reaches the last number of the network path, and then determines the number of packets to be transmitted.

Examples of calculation of the number of packets transmitted via each of three network paths among N number of network paths will now be described with reference to FIG. 4. It is assumed that the three network paths are determined as not being in congestion state and thus included in the available network path list. Latency differences ΔD₁ (D₁−D₂) and ΔD₂ (D₂−D₃) between network paths are calculated, and the number of packets to be transmitted via each network path is calculated using a packet reception interval τ₁, τ₂, and τ₃. For example, it is given that D₁, D₂ and D₃ are 8, 4, and 1, respectively, ΔD₁ is 4, ΔD₂ is 3, and τ₁, τ₂, and τ₃ are 4, 2, and 1, respectively. While one packet is transmitted via network path 1 with the largest latency, two (n₁=ΔD₁/τ₂=2) packets are transmitted via network path 2. During the latency difference between network path 1 and network path 2, more packets can be transmitted via network path 2 in inverse proportional to the reception interval, and specifically, more packets, as many as ΔD₁/τ₂, can be transmitted via network path 2 than network path 1.

The number of packets to be transmitted via network path 3 while one packet is being transmitted via network path 2 is three (n₂=ΔD₂/T₃=3). A calculation method for the number of packets to be transmitted is not limited to the aforesaid method. In one exemplary embodiment, if ΔD/τ is calculated as a decimal number, the decimal number is changed into an integer, and then the integer is determined as the number of packets. For example, given that n₁=ΔD₁/τ₂=0.5 and n₂=ΔD₂/τ₃=0.6, a ratio between n₁ and n₂ is converted into a ratio between two smallest natural numbers (i.e., 5:6), and these natural numbers are determined as is the number of packets to be transmitted via the respective network paths 1 and 2. In another exemplary embodiment, if ΔD/τ is calculated as a decimal number, the calculation result is rounded up. For example, given that n₁=ΔD₁/τ₂=1.5 and n₂=ΔD₂/τ₃=2.6, n₁ is rounded up to 2 and n₂ is rounded up to 3. In yet another exemplary embodiment, if ΔD/τ is calculated as a decimal number, the calculation result is rounded off. For example, given that n₁=ΔD₁/τ₂=1.5 and n₂=ΔD₂/τ₃=2.4, n₁ is rounded off to 2 and n₂ is rounded off to 2. The way of processing the calculation result of ΔD/τ is not limited to the aforementioned embodiments. Once the number of packets to be transmitted via each network path has been determined, the sequence numbers are allocated to the network paths by taking into consideration the latencies and the packet reception intervals of each network path, such that the client 20 can sequentially receive the packets.

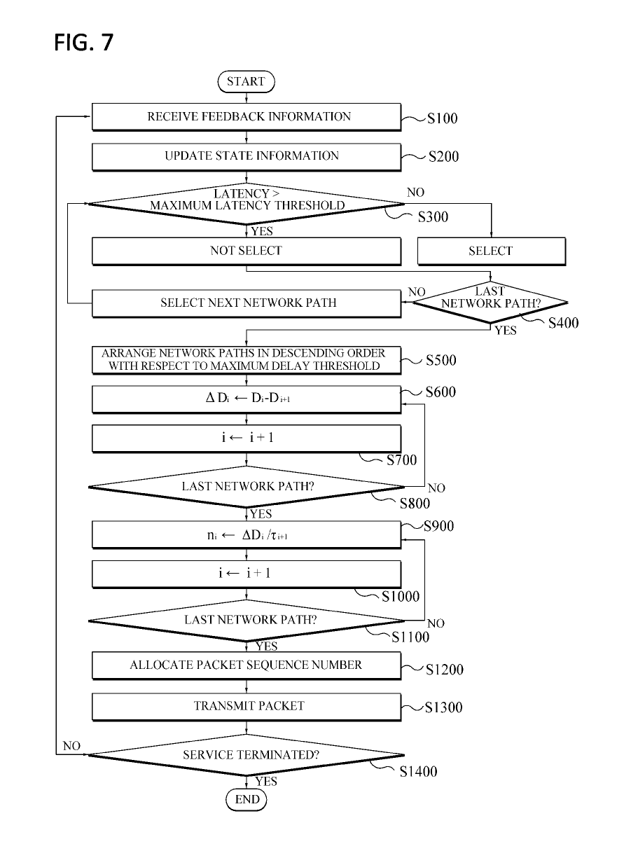

In FIG. 4, numbers 1 to 21 shown at the end of arrows that are in contact with the three network paths connected to the client 20 denote the arrival order of packets sent from the packet transmission apparatus 10. For example, a packet sent via network path 3 arrives first at the client 20, so the number 1 is allocated to the packet. Although packets are sent via network path 1, 2, and 3 at the same time, they arrive at the client 20 at different times due to the packet latencies. For example, the packet sent via network 2 is the fourth packet that arrives at the client 20 and the packet sent via network 1 is the eleventh packet. As shown in FIG. 7, the arrival order of packets can obtained through the packet latency and the packet reception interval of each network path. When sequence numbers are allocated to the packets in accordance with the arrival order and then the packets are sent to the client 20 according to the sequence numbers, it is possible to prevent out-of-order arrival.

In one exemplary embodiment, the sorter 121 arranges selected network paths in descending order based on their maximum latency thresholds. Aspects of the present disclosure are not limited thereto, such that the sorter 121 creates arrangement data by sorting the network paths in various ways, for example, in ascending order. The packet allocator 130 calculates the number n₁ of packets to be transmitted via the (i+1)-th network path during ΔD₁ by dividing ΔDᵢ by τ₍ᵢ₊₁₎ of each of the network paths that have been arranged by the sorter 121 in descending order. As seen in FIG. 4, the network paths are arranged in descending order based on their maximum latency thresholds, wherein network path 1 has the greatest maximum delay latency and the maximum delay latency decreases with the increase in i. In one exemplary embodiment, the sorter 121 is implemented by sets of program instructions to be executed on a microprocessor included in the packet transmission apparatus 10. Aspects of the present disclosure are not limited thereto, such that the sorter 121 may be implemented by dedicated hardware, for example, sequential and/or combinational logic circuit.

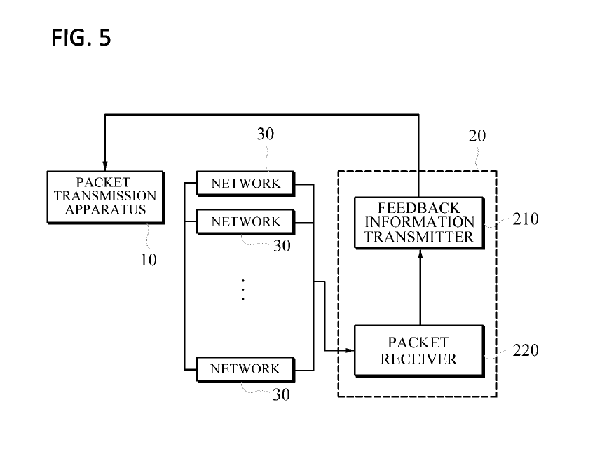

FIG. 5 is a diagram illustrating a configuration of a client according to an exemplary embodiment. As shown in FIG. 5, the client 20 includes a feedback information transmitter 210 and a packet receiver 220. The packet receiver 220 receives packets sent from the packet transmission apparatus 10. The feedback information transmitter 210 transmits feedback information to the packet transmission apparatus 10 in response to receiving the packets. The feedback information indicates state information. That is, the feedback information contains at least one of the following information: a packet latency, a packet reception interval, a throughput, and a packet loss probability of each network path. The feedback information is not limited to the aforesaid information and may include any factors that allow the evaluation of the network performance. The factors may include the delay spread, an error rate, multicasting/broadcasting capabilities, document cache, and the like, which have been described in detail above.

Although not illustrated, the client 20 may include a plurality of interfaces that enable the connection to the multiple networks 30. The interfaces may be configured to implement functions of a data link layer and a physical layer. For example, the interfaces may be configured to implement a physical layer technology and a data link layer technology that support the connection to a wireless network 30. In another example, the interfaces may be configured to implement a physical layer technology and a data link layer technology that support the connection to a code division multiple access (CDMA) mobile communication network. In yet another example, the interfaces may be configured to implement a physical layer technology and a link layer technology that support the connection to a 3GE network, as well as to implement a session setting technology. IP addresses are allocated to the respective interfaces for operation.

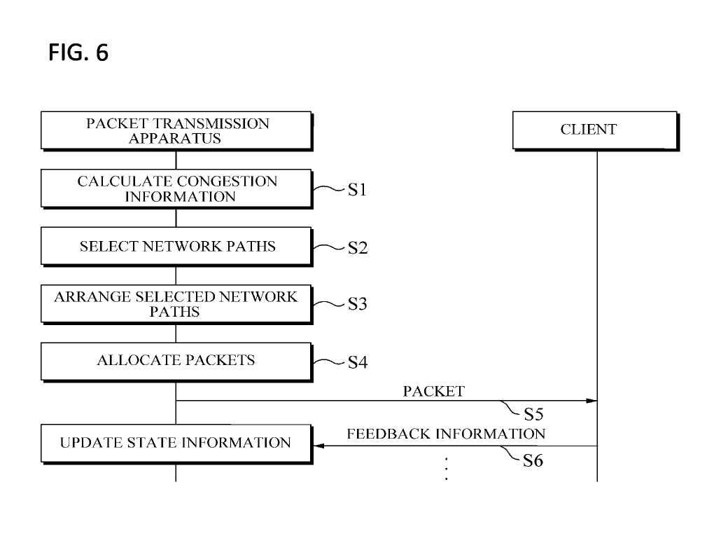

FIG. 6 is a flowchart illustrating a method of packet transmission between a packet transmission apparatus and a client according to an exemplary embodiment. The method includes the operations of: calculation of congestion information; selection of a path; and allocation of a packet. Referring to FIG. 6, in S1, the packet transmission apparatus calculates congestion information of each network path based on state information of each of multiple network paths.

In one exemplary embodiment, the congestion information of each network path is calculated based on state information of each network path. The state information contains at least one of the following: a packet latency, a packet reception interval, a throughput, and a packet loss probability.

For example, the packet reception interval may be an interval at which the client receives packets through one of the network paths. In another example, the packet reception interval may be an interval at which the packet transmission apparatus transmits packets.

The packet throughput is also called a bit rate, which is the number of bits that pass a given point in the network in a given amount of time when two terminal systems, i.e., the packet transmission apparatus and the client communicate with each other.

The packet loss probability refers to a probability that a packet traveling in the network will be lost due to interruption or the like.

The state information is not limited to the aforementioned information and includes any factors that allow the evaluation of the network performance. The factors may include the delay spread, an error rate, multicasting/broadcasting capabilities, document cache, and the like. For example, the delay spread is a physical jitter that is distinguished from a jitter which is caused only by transmission equipment. All networks 30 have a physical jitter. This is because a repeater that reforms a signal may sometimes operate unpredictably or, in the case of a metal conductor, a propagation delay and the like is changed according to changes in temperature.

For example, the error rate depends on data changes, data loss, data duplication, out-of-order transmission of data. A network error is measured as a bit error rate, a packet/cell error rate, a packet/cell loss probability, and the like.

In one exemplary embodiment, in S1, the congestion information is calculated by comparing the maximum latency threshold, which is calculated based on the state information, to a current latency of the packet transmitted via the network path. The congestion information contains data of comparison between the maximum latency threshold and the current latency. If the maximum latency threshold of an arbitrary network is smaller than the current latency of the packet, the congestion information is generated in S1 to indicate that the maximum latency threshold is smaller than the current latency. In one exemplary embodiment, the maximum latency threshold is the maximum packet latency during which a packet loss does not occur, and after which a packet loss starts occurring. In another exemplary embodiment, the maximum latency threshold is the longest packet latency during which a packet loss does not occur. However, aspects of the present disclosure are not limited thereto, such that the maximum latency threshold can be set to a different value according to the type of client.

In one exemplary embodiment, in S1, congestion information of the current network path is calculated, and it is checked whether congestion information has been completely calculated for all network paths connected to the client. If there are remaining network paths for which the congestion information has not been yet calculated, one of the remaining network paths is selected and then its congestion information is calculated until the congestion information is calculated for all network paths.

In one exemplary embodiment, in S2, a network path to be used for packet transmission is selected based on the calculated congestion information of each network path. Based on the calculated congestion information, a network path that has a smaller current packet latency than the maximum latency threshold is selected. In S2, the selected network path is added to a list of network paths available for transmission of a packet. There may be one or more selected network paths or none at all.

In one exemplary embodiment, the packet transfer method may include the operation of sorting as depicted in S3. In S3, whether each network is used for packet transmission is determined, and then arrangement data is generated by sorting selected network paths based on their maximum latency thresholds. For example, in S3, the selected network paths are arranged in descending order based on their maximum latency thresholds. Aspects of the present disclosure are not limited thereto, such that the sorter 121 creates arrangement data by sorting the network paths in various ways, for example, in ascending order.

In one exemplary embodiment, in S4, the number of packets to be transmitted and the sequence numbers of the packets are allocated to each network path. In S4, the number of packets to be transmitted and the sequence numbers of the packets are allocated to each network path based on a packet latency difference between networks and the packet reception intervals of the networks. As shown in FIG. 4, ΔDᵢ denotes a difference between a latency Dᵢ of the i-th network path and a latency D₍ᵢ₊₁₎ of the (i+1)-th network path, where i starts with 1. In S4, i is increased by one after ΔDᵢ is calculated, and whether the i-th network path is the last network path of the network path list is checked. If the i-th network path is not the last one, ΔDᵢ is continuously calculated until the i-th network path becomes the last network path of the network path list. If the number i reaches the last number of the network path, i is changed to 1 and the number nᵢ of packets to be transmitted via the (i+1)-th network path during ΔDᵢ is calculated by dividing ΔDᵢ by τ₍ᵢ₊₁₎.

In addition, in S4, the number of packets and the sequence numbers of the packets are allocated to each of the network paths that are connected to multiple interfaces included in the packet transmission apparatus. As shown in FIG. 4, once the number of packets to be transmitted via the (i+1)-th network path is determined, i is increased by one and whether the i-th network path is the last network path of the network path list is checked. If the i-th network path is the last network path, the number of packets to be transmitted via the network path in question is determined and i is not increased any longer. If the i-th network path is not the last one in the network path list, i is continuously increased by one until the number i reaches the last number of the network path, and then the number of packets to be transmitted is determined.

In S4, the number nᵢ of packets to be transmitted via the (i+1)-th network path during ΔDᵢ is calculated by dividing ΔDᵢ by τ₍ᵢ₊₁₎ of each of the network paths that have been arranged in descending order. As seen in FIG. 4, the network paths are arranged in descending order based on their maximum latency thresholds, wherein network path 1 has the greatest maximum delay latency and the maximum delay latency decreases with the increase in i.

Examples of calculation of the number of packets transmitted via each of three network paths among N number of network paths will now be described with reference to FIG. 4. It is assumed that the three network paths are determined as not being in congestion state and thus included in the available network path list. Latency differences ΔD₁ (D₁−D₂) and ΔD₂ (D₂−D₃) between network paths are calculated, and the number of packets to be transmitted via each network path is calculated using a packet reception interval τ₁, τ₂, and τ₃. For example, it is given that D₁, D₂ and D₃ are 8, 4, and 1, respectively, ΔD₁ is 4, ΔD₂ is 3, and τ₁, τ₂, and τ₃ are 4, 2, and 1, respectively. While one packet is transmitted via network path 1 with the largest latency, two (n₁=ΔD₁/τ₂=2) packets are transmitted via network path 2. During the latency difference between network path 1 and network path 2, more packets can be transmitted via network path 2 in inverse proportional to the reception interval, and specifically, more packets, as many as ΔD₁/τ₂, can be transmitted via network path 2 than network path 1.

The number of packets to be transmitted via network path 3 while one packet is being transmitted via network path 2 is three (n₂=ΔD₂/τ₃=3). A calculation method for the number of packets to be transmitted is not limited thereto. In one exemplary embodiment, if ΔD/τ is calculated as a decimal number, the decimal number is changed into an integer, and then the integer is determined as the number of packets. For example, given that n₁=ΔD₁/τ₂=0.5 and n₂=ΔD₂/τ₃=0.6, a ratio between n₁ and n₂ is converted into a ratio between two smallest natural numbers (i.e., 5:6), and these natural numbers are determined as the number of packets to be transmitted via the respective network paths 1 and 2. In another exemplary embodiment, if ΔD/τ is calculated as a decimal number, the calculation result is rounded up. For example, given that n₁=ΔD₁/τ₂=1.5 and n₂=ΔD₂/τ₃=2.6, n₁ is rounded up to 2 and n₂ is rounded up to 3. In yet another exemplary embodiment, if ΔD/τ is calculated as a decimal number, the calculation result is rounded off. For example, given that n₁=ΔD₁/τ₂=1.5 and n₂=ΔD₂/τ₃=2.4, n₁ is rounded off to 2 and n₂ is rounded off to 2. The way of processing the calculation result of ΔD/τ is not limited to the aforementioned embodiments. Once the number of packets to be transmitted via each network path has been determined, the sequence numbers are allocated to the network paths by taking into consideration the latencies and the packet reception intervals of each network path, such that the client can sequentially receive the packets.

In FIG. 4, numbers 1 to 21 shown at the end of arrows that are in contact with the three network paths connected to the client denote the arrival order of packets sent from the packet transmission apparatus. For example, a packet sent via network path 3 arrives first at the client, so the number 1 is allocated to the packet. Although packets are sent via network path 1, 2, and 3 at the same time, they arrive at the client at different times due to the packet latencies. For example, the packet sent via network 2 is the fourth packet that arrives at the client and the packet sent via network 1 is the eleventh packet. As shown in FIG. 4, the arrival order of packets can obtained through the packet latency and the packet reception interval of each network path. When sequence numbers are allocated to the packets in accordance with the arrival order and then the packets are sent to the client according to the sequence numbers, it is possible to prevent out-of-order arrival.

The packet transmission method includes the operation of packet transmission, as depicted in S5. In S5, a packet is transmitted through the network path for which the allocation of the number of packets and the packet sequence numbers has been completed. In S5, once the allocation of the number of packets and the packet sequence numbers for every network path connected to a plurality of interfaces has been completed, packets are transmitted according to the allocated number of packets and packet sequence numbers.

The packet transmission method includes the operation of updating of state information, as depicted in S6. In S6, upon reception of packets through the multiple network paths, state information that is contained in the feedback information sent from the client is updated. The feedback information contains at least one of the following information: a packet latency, a packet reception interval, a throughput, and a packet loss probability of each network path. The state of the network path may change over time. The number of packets to be transmitted via each network path and the sequence numbers of the packets depend on the congestion information calculated based on the state information of the network path. Once the state information is updated, the number of packets and the sequence numbers of the packets that are suitable to the current state of each network path can be allocated to each network path. The client transmits feedback information to the packet transmission apparatus, each time receiving the packet, and the packet transmission apparatus calculates congestion information based on the state information, each time receiving the feedback information. When the congestion information that includes traffic status of each network path is altered, the number of packets and the sequence numbers of the packets for each network path may be modified in order to ensure the optimal quality of wireless communication. As the packet transmission apparatus continuously receives feedback information from the client and the state information of each network path is updated in S6, it is possible to immediately and flexibly response to changes in communication environment. The state information is not limited to the aforesaid information and may include any factors that allow the evaluation of the network performance. The factors may include the delay spread, an error rate, multicasting/broadcasting capabilities, document cache, and the like. The packet latency, the packet reception interval, the throughput, the packet loss probability, the delay spread, and the error rate have been described in detail above.

FIG. 7 is a flowchart illustrating in detail the packet transmission method of claim 6. In S6 of FIG. the packet transmission apparatus receives the feedback information from the client as depicted in S100, wherein the feedback information includes at least one of the following: the packet latency, the packet reception interval, the throughput, the packet loss probability, and updates the state information as depicted in S200. In S300, congestion information is calculated based on the state information. In addition, in S300, the current latency of the packet is compared to the maximum latency threshold with reference to the calculated congestion information, and then a network path of a smaller current latency is selected and then added as a network path available for transmission. The comparison between the current latency of the packet and the maximum latency threshold is performed for each network path, and then a network path of a smaller current latency is selected and then is added as an available network path.

In S500, data is generated by sorting the selected network paths based on their maximum latency thresholds. In S4 of FIG. 6, the number of packets to be transmitted and the sequence numbers are allocated to each network path based on packet latency difference between network paths and the packet reception interval. In S600, ΔDᵢ denotes a difference between a latency Dᵢ of the i-th network path and a latency D₍ᵢ₊₁₎ of the (i+1)-th network path, where i starts with 1. In S700, i is increased by one after ΔDᵢ is calculated, and whether the i-th network path is the last network path of the network path list is checked, as depicted in S800. If the i-th network path is not the last one, ΔDᵢ is continuously calculated until the i-th network path becomes the last network path of the network path list, as depicted in S600. If the number i reaches the last number of the network path, i is changed to 1 and the number nᵢ of packets to be transmitted via the (i+1)-th network path during ΔD₁ is calculated by dividing ΔDᵢ by τ₍ᵢ₊₁₎, as depicted in S900. After the calculation of n₁, i is increased by one, as depicted in S1000, and whether the i-th network path is the last network path of the available network path list is determined, as depicted in S1100. If it is determined in S1100 that the i-th network path is not the last network path of the list, the flow goes to operation S900 in which nᵢ is calculated, and nᵢ is continuously calculated by increasing the number i by one until i reaches the last number of the network path. In S1200, sequence numbers are allocated to the network paths according to the order of packets arriving in accordance with the packet latencies and packet reception intervals. The packet transmission method repeats operations S100 to S1400 until the service is terminated.

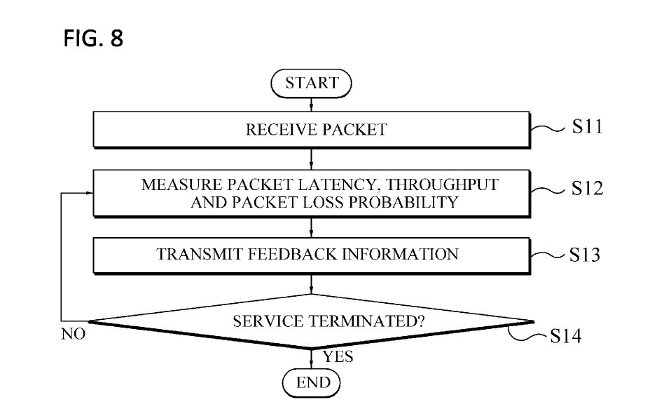

FIG. 8 is a flowchart illustrating how the client receives a packet via multiple network paths and transmits feedback information. The client receives a packet from a packet transmission apparatus, as depicted in S11. In S12, the client creates feedback information which contains at least one of the following information: a packet latency, a packet reception interval, a throughput, and a packet loss probability of each network path. In S13, the client transmits the feedback information to the packet transmission apparatus. The client repeatedly performs operations S11 to S14 until the service is terminated.

According to the exemplary embodiments, it is possible to prevent a packet loss and throughput degradation by determining the number of packets to be transmitted via each network path based on the degree of congestion on each network path.

In addition, it is also possible to increase the entire throughput by solving the problem of reduction in the throughput due to out-of-order packets being recognized as lost packets.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A packet transmission apparatus for transmitting a packet using multi-homing based network paths, the packet transmission apparatus comprising:
a congestion information calculator configured to calculate congestion information of each of a plurality of network paths based on state information of each network path;
a path selector configured to select a network path to be used for packet transmission based on the calculated congestion information; and
a packet allocator configured to allocate, to the selected network path, the number of packets to be transmitted through the selected network path and sequence numbers of the packets.

2. The packet transmission apparatus of claim 1, wherein the congestion information calculator calculates the congestion information based on state information of each of the plurality of network path, and the state information contains at least one of the following: a packet latency, a throughput, and a packet loss probability.

3. The packet transmission apparatus of claim 1, further comprising:
a state information updater configured to update state information that is included in feedback information sent from a client which received a packet through each network path.

4. The packet transmission apparatus of claim 1, wherein the congestion information calculator calculates the congestion information of each network path by comparing a maximum latency threshold, calculated based on state information, to a current latency of a packet that is transmitted via the network path.

5. The packet transmission apparatus of claim 4, wherein the path selector selects a specific network path as the network path to be used for packet transmission when it is determined based on the calculated congestion information that a currently latency of a packet transmitted via the specific network path is smaller than the maximum latency threshold.

6. The packet transmission apparatus of claim 4, further comprising:
a sorter configured to create data by arranging network paths which are selected, based on the maximum latency threshold of each network path, from among the network paths that the path selector determines to be used for packet transmission.

7. The packet transmission apparatus of claim 1, wherein the packet allocator allocates, to each network path, the number of packets to be transmitted through the network path and the sequence number of the packets based on a packet latency difference between the network paths and a packet reception interval of the network path.

8. The packet transmission apparatus of claim 1, wherein the packet allocator allocates the number of packets to be transmitted and sequence numbers of the packets to each of network paths which are connected to a plurality of interfaces included in the packet transmission apparatus.

9. The packet transmission apparatus of claim 1, further comprising: a packet transmitter configured to transmit packets through a network path to which the number of packets to be transmitted and the sequence numbers of the packets are completely allocated.

10. A method for transmitting packets using multi-homing based network paths, the method comprising:
calculating congestion information of each of a plurality of network paths based on state information of each network path;
selecting a network path to be used for packet transmission based on the calculated congestion information; and
allocating, to the selected network path, the number of packets to be transmitted through the selected network path and sequence numbers of the packets.

11. The method of claim 10, further comprising: updating state information that is included in feedback information sent from a client which received a packet through each network path.

12. The method of claim 10, wherein the calculating of the congestion information of each network path is performed by comparing a maximum latency threshold, calculated based on state information, to a current latency of a packet that is transmitted via the network path.

13. The method of claim 10, wherein in the selecting of the network path, a specific network path is selected as the network path to be used for packet transmission when it is determined based on the calculated congestion information that a currently latency of a packet transmitted via the specific network path is smaller than the maximum latency threshold.

14. The method of claim 13, further comprising:
creating data by arranging network paths which are selected, based on the maximum latency threshold of each network path, from among the network paths that the path selector determines to be used for packet transmission.

15. The method of claim 10, wherein in the allocation of the number of packets and the sequence numbers, the number of packets to be transmitted and sequence numbers of the packets are allocated to each network path based on a packet latency difference between network paths and a packet reception interval of the network path.
